(19) United States
(12) Patent Application Publication
(10) Pub. No.: US 2006/0216584 A1
(43) Pub. Date: Sep. 28, 2006

(54) Oxidation resistant electrolyte absorber

(76) Inventor: Michael Cheiky, Thousand Oaks, CA (US)

Correspondence Address: Marvin E. Jacobs;KOPPEL & JACOBS, Suite 215, 2151 Alessandro Drive, Ventura, CA, 93001, US

(21) Appl. No.: 11/089,658

(22) Filed: Mar. 24, 2005

(51) Int. Cl. H01M 2/16; H01M 2/18; B05D 3/02

(52) U.S. Cl. 429/144; 429/255; 429/250; 427/384; 429/246

(57) ABSTRACT

An oxidation-resistant electrolyte absorber, especially for use adjacent a divalent silver containing cathode in a secondary silver-zinc battery is prepared by saturating a porous web with a dilute solution of a vinyl alcohol polymer to form a film of the solution on the surfaces of the pores of web. The polyvinyl alcohol polymer is cross-linked to form an oxidation-resistant coating on the surfaces of the pores while retaining the liquid absorption capacity of the porous web.

### TECHNICAL FIELD

This invention relates to rechargeable alkaline batteries and, more particularly, this invention relates to an oxidation-resistant electrolyte absorbers for alkaline batteries, especially for placement adjacent the strong oxidation environment of a divalent silver cathode of a silver-zinc rechargeable battery.

### BACKGROUND OF THE INVENTION

There is an ever increasing need for lighter, more powerful batteries. This is driven in part by devices such as laptops and cameras that demand more energy and power from lighter batteries. Silver-zinc batteries have long been recognized as possessing superior gravimetric and volumetric energy densities.

It is common practice in building rechargeable alkaline batteries to incorporate an electrolyte absorber. The absorber acts as an electrolyte reservoir. It is usually formed of a porous felt or mat that retains and dispenses electrolyte.

The absorber typically absorbs several times its weight of electrolyte. Alkaline batteries such as silver-zinc usually have absorbers on both the cathode and anode sides. Some batteries such as nickel-hydrogen have no absorbers at all. In this case the separators perform the function of an absorber. In silver-zinc batteries, the absorber on the cathode side experiences a particularly strong oxidative environment. Divalent silver oxide is one of the strongest oxidizing agents known. Since the absorber is in direct contact with the oxidative surface, it should be particularly resistant to oxidation by the divalent silver species.

The absorber should also possess many of the criteria required of separators. The absorber should also offer minimal ionic resistance. It should be permeable to water and hydroxyls, resistant to oxidation by silver oxide, resistant to attack by alkaline electrolyte and be able to retard the migration of silver ions to the counter-electrode. Preferably also, as the adjacent separators often contain cellulose, which is readily degraded by divalent silver oxide it is advantageous if that the absorber can retard the migration of silver ions to the separator.

Absorbers on the cathode side in silver-zinc batteries typically have been made of regenerated cellulose blended with polyolefins, nylon, or microporous polypropylene made wettable by a special coating. The material can be in mat form or hydrogel form. These materials are seriously degraded in the strong oxidation envorinment of a divalent silver cathode.

Statement of the Prior Art

U.S. Pat. No. 4,224,394 (Schmidt) teaches forming a porus separator by applying a coating to an electrolyte absorber and comprising a fibrous and porous substrate such as a sheet of asbestos and rubber that is resistant to strong alkali and oxidation. The coating composition includes an admixture of a polymeric binder, a hydrolyzable polymeric ester and inert fillers. When the separator is immersed in electrolyte, the polymeric ester of the film coating reacts with the electrolyte forming a salt and an alcohol. The alcohol enters the electrolyte and the salt expands the binder to increase porosity of the absorber.

U.S. Pat. No. 4,247,606 (Uetani et al) describes the use of an absorber of a non-woven fabric made of Vinylon fibers or Nylon fibers in a silver-zinc battery—the improvement relating to silver grain size on the molded cathode.

U.S. Pat. No. 4,154,912 (Philipp et al) describes a two step method for forming a PVA separator for an alkaline battery in which the 1,2 diol units are initially cleaved and then the 1,3 diol units are subsequently acetalized.

U.S. Pat. No. 4,218,280 also of Philipp et al describes an irradiation technique for crosslinking a PVA film to form a self-supporting sheet.

Takamura et al in U.S. Pat. No. 3,951,687 describe a tough, non-porous PVA separator for nickel-zinc batteries formed by coating both sides of a porous alkaline resistant nonwoven substrate (0.05 to 0.15 mm thick) with a mixture of an aqueous PVA solution (at least 10% by weight) and at least one selected from boric acids and metal oxides having low solubility to alkali solution and then drying the nonwoven fabric thus coated. A similar treatment for forming a PVA separator, also by Takamura et al, is described in U.S. Pat. No. 4,037,033. The absorber and separator may be treated with a surfactant. The separators by Takamura are constructed to prevent dendrite growth starting at the anode. The metal oxides increase the hydrophobicity of the alkaline electrolyte and the cations formed from the metal oxides prevent, due to repulsion of charges, the zinc ions from passing through the separator to the anode electrode side of the battery.

U.S. Pat. No. 4,361,632 (Weber et al) discusses a method to mass produce a coating for absorbers in alkaline batteries. Weber mechanically bonds wetable absorber web with an admixture of a noncrosslinked polyvinyl alcohol solution, inert fillers, a dispersing agent, a plasticizer, a cross-linking agent, a low molecular weight alcohol-water mixture and an acid catalyst. The major constituent of the coating is filler. This admixture necessarily produces a porous absorber when introduced into KOH electrolyte as the dispersant and plasticizer leach away.

Polyvinyl alcohol has been taught as separator in silver-zinc batteries in the treatise “Silver-Zinc Battery”, 4th edition (2003), by Albert Himy. Hung discloses a 1 or 1.5 mil thick PVA film has been used as separator in silver-zinc batteries. The separator is made by spraying or dipping a layer of an inorganic material in a PVA solution.

The prior art does not disclose the use of electrolyte absorbers resistant to highly oxidative environment extant in silver peroxide batteries, nor does it discuss the use of such an absorber as a means to retard oxidation of cellulose containing separators by divalent silver oxide.

Statement of the Invention

It has been discovered in accordance with the invention that cellulose containing electrolyte absorbers adjacent a highly oxidative silver cathode are quickly degraded and shorten the life of secondary silver-zinc batteries.

An oxidation-resistant, cellulose-based alkaline electrolyte absorber is provided by the invention. The absorber is prepared by impregnating a fibrous absorber mat with excess of a dilute solution of polyvinyl alcohol until the mat is saturated. The PVA solution forms a film on the surfaces of the fibrous mat. The PVA in the film is cross-linked to form an oxidation-resistant absorber film on the surfaces of the fibers and pores in the mat. The absorber is found to have excellent resistance to oxidation when adjacent a silver containing cathode. The absorber also protects the adjacent cellulose-containing separator from oxidation. The PVA-film coated absorber still absorbs electrolyte and remains permeable to water and hydroxyl ions. The absorber provides minimal ionic resistance and is resistant to attack by alkaline electrolyte. It retards the migration of silver ions which also protects the adjacent separator from degradation.

The untreated porous absorber may be any number of numerous hydrophilic woven or nonwoven materials, including nylon, wettable propylene, regenerated cellulose fibers, and regenerated cellulose/polyolefin blends such as polyethylene and polypropylene. These materials typically absorb several times electrolyte by weight. By themselves these materials are not highly resistant to an oxidative environment.

Oxidation resistance is conferred onto the porous absorber by the impregnation of crosslinked polyvinyl alcohol-containing polymers. The polyvinyl alcohol in the present invention should preferably be sufficiently hydrolyzed to conduct hydroxyl ions. This level of hydrolysis can typically range from 80 to 99+%. PVA may be present in the polymer as a polymer of vinyl alcohol copolymerized with monomers such as vinyl acetate, ethylene, vinyl butyral, acrylamide, maleic anhydride or any mixture of these, provided that the vinyl alcohol content is greater than 60% mole basis of the mixture. PVA may also be incorporated as a block copolymer with a vinyl alcohol content again greater than 60% mole basis.

The degree of polymerization (D.P.) of the PVA is sufficient for the production of a film. Generally molecular weights greater than 5,000 will yield good films.

Polyvinyl alcohol, of hydrolysis greater than 80%, is somewhat soluble in cold water and completely soluble in hot water. This solubility precludes the long-term use of untreated polyvinyl alcohol in an alkaline environment. Light crosslinking of PVA renders it insoluble in an aqueous environment. The cross-linking is sufficient to render the vinyl alcohol polymer insoluble in alkaline environment of the battery, suitably at least 1 mole percent of the aldelyde groups are cross-linked to adjacent chains of polymer cross-linking above 25 molar percent is not required for insolubility and may render the film too rigid and brittle.

Light crosslinking may be achieved with a variety of known crosslinking agents. Amongst these include monoaldehydes such as formaldehyde and glyoxilic acid, as well as aliphatic, furyl, or aryl dialdehydes such as glutaraldehyde, 2,6 furyldialdehyde and terephthaldehyde. They also include dicarboxylic acids such as oxalic acid and succinic acid. Additionally boron compounds such as boron oxide, boric acid, metaboric acid and the salts of these serve as excellent crosslinking agents for PVA. Suitable metal oxides such as calcium oxide, titanium oxide, magnesium oxide, zirconium oxide and aluminum oxide as well as organometallic compounds containing the core metals of these oxides, may also be used. Preferred crosslinking agents are ammonium zirconium carbonate (Bacote® 20) and Tyzor 212® (Dupont). The above crosslinking agents may be used singly or in combination.

The PVA may deposited onto the porous substrate using a variety of techniques known to those skilled in the art of membrane fabrication. These techniques include casting onto the substrate, painting manually or via rollers, spraying, or co-extrusion onto a conveyor belt. The deposited PVA preferably coats the entire surface of the fibers and pores while retaining absorption for electrolyte. After deposition, the final cross-linked form of the absorber is generated by drying the polyvinyl alcohol-containing polymer. Drying may be accomplished by room temperature evaporation or forced evaporation such as blowing air or heating the solution and particles.

Besides sealed battery applications, the current invention may be used in unsealed electrochemical systems as an electrode wrapper.

These and many other features and attendant advantages of the invention will become apparent as the invention becomes better understood by reference to the following detailed description when considered in conjunction with the accompanying drawings.

### BRIEF DESCRIPTION OF THE DRAWINGS

FIG. 1 is view in section of a battery containing the absorber according to the invention;

FIG. 2 is a side view of the absorber before impregnation;

FIG. 3 is an enlarged view in section taken along line 3-3 of FIG. 2

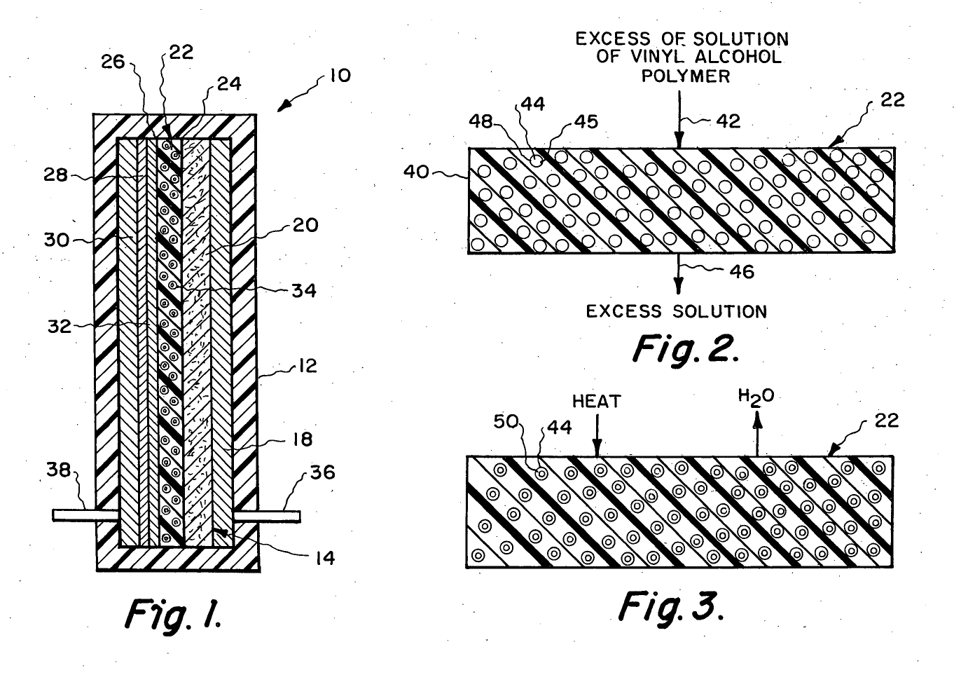

### DETAILED DESCRIPTION OF THE INVENTION

A battery 10 according to the invention includes an alkaline-resistant battery case 12 containing the electrodes assembly 14. The electrode assembly 14 includes a cathode current collector 18 such as an expanded metal sheet on which is mounted a silver oxide cathode 20 containing particles of divalent silver oxide and particles of fluorocarbon resin such as polytetrafluoroethylene sintered together to form a porous structure. An electrolyte absorber 22 is placed adjacent the cathode 20. A separator such as the recombinant separator 24 disclosed in U.S. Pat. No. 6,733,920 is placed adjacent the absorber layer 22. The anode compartment 26 adjacent the separator contains a zinc containing anode 28. The anode 28 is formed of a current collector 30 such as an expanded sheet, a wire net, or a punched sheet of silver, silver-plated copper or brass may be used as the current collector. An anode layer 32 includes 1-10% of zinc and/or zinc oxide powder and other metal oxides such as calcium oxide and/or bismuth oxide dispersed in a gelling agent such as polyethylene oxide. An optional absorber layer may be present between the anode layer 32 and the separator 24. Electrodes 36, 38 are connected to the current collectors 18, 30. The absorbers 22, 34 contain the alkaline liquid electrolyte.

Referring now to FIGS. 2-3, the oxidation resistant electrolyte absorber 22 is formed by adding an excess of a dilute solution 42 of a polyvinyl alcohol homo-or copolymer to a mat 40 of alkali-resistant material as previously defined. The solution saturates the mat 40. The low viscosity, dilute solution 42 (0.1 to 10%) preferably 0.3 to 7%, by weight, is able to flow through the mat forming a film 48 of solution which coats the fibers 44 and pores 45. The excess solution 46 drains from the mat 40.

High viscosity polyvinyl alcohol solutions such as disclosed by Takamura have a polyvinyl alcohol content above 10% by weight and are designed to form a tough, non-porous separator sheet which prevents dendrites from entering the opposite electrode compartment.

After water is evaporated from the surfaces of fibers and pores of the absorber 22 the vinyl alcohol polymer cross-links forming an oxidation resistant protective film 50 on the fibers and pores. However, the capacity for absorbing liquid is virtually unchanged diminishing from 1-5% by weight of the untreated mat.

The following examples illustrate embodiments of the present invention.

### EXAMPLE 1

0.80 g polyvinyl alcohol (Aldrich) of molecular weight 100,000, 99+% hydrolyzed, is dissolved in 100 ml water at 80C. Upon cooling to room temperature, 0.21 g ammonium zirconium carbonate crosslinking agent is added to the solution. A durable porous absorber, such as a mixture of regenerated cellulose and polyethylene fibers weighing 0.30 g is placed on a flat Teflon-coated surface. The PVA solution containing the crosslinking agent is spread on the absorber so as to completely saturate the surfaces of the pores and fibers in the mat. Water is evaporated at 80C from the absorber surface. As the water evaporates, the crosslinking reaction takes place, forming a porous mat structure and rendering the PVA water insoluble. The electrolyte absorption of the coated absorber was compared to the electrolyte absorption of an uncoated absorber. There was less than 2% difference in the absorption properties of the two absorbers. The coated absorber was found to be remarkably resistant to oxidation in the presence of Ag₂O.

### EXAMPLE 2

PVA prepared as above. 20 ml of solution above (containing 160 mg PVA and 4 mg AZC and 0.4 mg oxalic acid) is put on 240 mg cellulose-based paper and the water is evaporated. The absorber was resistant to oxidation in the presence of Ag₂O and its capacity to absorb electrolyte was substantially the same as the original mat.

It is to be realized that only preferred embodiments of the invention have been described and that numerous substitutions, modifications and alterations are permissible without departing from the spirit and scope of the invention as defined in the following claims.

What is claimed is:

1. An oxidation-resistant electrolyte absorber comprising;
a porous web of alkali-resistant material; and
a film of oxidation-resistant, cross-linked vinyl alcohol polymer coating the surfaces of the pores of the web, said web substantially retaining its absorption capacity for liquid electrolyte and being resistant to strong oxidizing agents.

2. An electrolyte absorber according to claim 1 in which the web is selected from the group consisting of regenerated cellulose blended with a polyolefin, nylon and wettable microporous polypropylene.

3. An electrolyte absorber according to claim 1 in which the vinyl alcohol polymer contains at least 60 mol percent vinyl alcohol and is hydrolyzed to at least 80%.

4. An electrolyte absorber according to claim 3 in which the vinyl alcohol polymer is a copolymer of vinyl alcohol and at least one monomer selected from the group consisting of vinyl acetate, ethylene, vinyl butyral, acrylamide, maleic anhydride.

5. A method of preparing an oxidation-resistant electrolyte absorber comprising the steps of;
saturating a porous web with a dilute solution of a vinyl alcohol polymer to form a film of the solution on the surface of the pores of the web;
removing excess solution from the pores;
cross-linking the vinyl alcohol polymer to form a coating of oxidation-resistant vinyl alcohol polymer on the surfaces of the pores.

6. A method according to claim 5 in which the vinyl alcohol polymer contains at least 60 mat percent vinyl alcohol.

7. A method according to claim 6 in which the vinyl alcohol polymer is a copolymer of vinyl alcohol and a monomer selected from the group consisting of vinyl acetate, ethylene, vinyl butyral, acrylamide, maleic anhydride.

8. A method according to claim 7 in which the cross-linking agent is selected from at least one of the groups consisting of monoaldehydes, aliphatic, furyl or argyl dialdehydes, dicarboxylic acids, boron compounds, metal oxides and organometallic oxides.

9. A method according to claim 8 in the cross-linking agent is selected from at least one of the group consisting of ammonium zirconium carbonate and oxalic acid.

10. A method according to claim 1 in which the absorption capacity of the coated web is no less than 95% the absorption capacity of the uncoated web.

11. A cathode for a silver secondary battery comprising in combination;
a cathode containing divalent silver; and
an electrolyte absorber as defined in claim 1 adjacent the surface of the cathode.

12. A secondary battery comprising in combination;
a battery case containing the cathode defined in claim 11, an absorber as defined in claim 1 adjacent the cathode a separator, a zinc anode and alkaline electrolyte;
a terminal connected to the anode; and
a second terminal connected to the cathode.
